(19) United States
(12) Patent Application Publication
(10) Pub. No.: US 2022/0035969 A1
(43) Pub. Date: Feb. 3, 2022

(54) SIMULATION METHOD, SIMULATION APPARATUS, FILM FORMING APPARATUS, ARTICLE MANUFACTURING METHOD AND NON-TRANSITORY STORAGE MEDIUM

(71) Applicant: CANON KABUSHIKI KAISHA, Tokyo (JP)

(72) Inventors: Sentaro Aihara, Tochigi (JP); Yuichiro Oguchi, Tokyo (JP)

(21) Appl. No.: 17/375,117

(22) Filed: Jul. 14, 2021

(30) Foreign Application Priority Data
Jul. 29, 2020 (JP) 2020-128506

(51) Int. Cl. G06F 30/20; G03F 7/00

(52) U.S. Cl. CPC G06F 30/20; G03F 7/0002

(57) ABSTRACT

The present invention provides a simulation method of predicting a behavior of a curable composition in a process of bringing a plurality of droplets of the curable composition arranged on a first member into contact with a second member and forming a film of the curable composition in a space between the first member and the second member, the method including for each of the plurality of droplets of the curable composition, obtaining, based on whether the droplet merges with an adjacent droplet, an evaluation value for evaluating a relationship regarding a degree of merging with the adjacent droplet, and displaying, together with information indicating a state of the droplet corresponding to the evaluation value, the evaluation value obtained in the obtaining.

### BACKGROUND OF THE INVENTION

### Field of the Invention

The present invention relates to a simulation method, a simulation apparatus, a film forming apparatus, an article manufacturing method, and a storage medium.

### Description of the Related Art

There is provided a film forming technique of forming a film made of a cured product of a curable composition on a substrate by arranging the curable composition on the substrate, bringing the curable composition into contact with a mold, and curing the curable composition. Such film forming technique is applied to an imprint technique and a planarization technique. In the imprint technique, by using a mold having a pattern, the pattern of the mold is transferred to a curable composition on a substrate by bringing the curable composition on the substrate into contact with the pattern of the mold and curing the curable composition. In the planarization technique, by using a mold having a flat surface, a film having a flat upper surface is formed by bringing a curable composition on a substrate into contact with the flat surface and curing the curable composition.

The curable composition is arranged in the form of droplets on the substrate, and the mold is then pressed against the droplets of the curable composition. This spreads the droplets of the curable composition on the substrate, thereby forming a film of the curable composition. At this time, it is important to form a film of the curable composition with a uniform thickness and not to leave bubbles in the film. To achieve this, the arrangement of the droplets of the curable composition, a method and a condition for pressing the mold against the curable composition, and the like are adjusted. To implement this adjustment operation by trial and error using an apparatus, enormous time and cost are required. To cope with this, development of a simulator that supports such adjustment operation is desired.

Japanese Patent No. 5599356 discloses a simulation method for predicting wet spreading and gathering (merging of droplets) of a plurality of droplets arranged on a pattern forming surface, and a method of generating a droplet arrangement pattern utilizing the prediction. Japanese Patent No. 5599356 also discloses that the height distribution of droplets with respect to the generated droplet arrangement pattern is calculated, and the droplet arrangement is adjusted such that the height distribution of droplets falls within a predetermined range.

On the other hand, in an imprint process, it is required to grasp the amount of a bubble confined between droplets of a curable composition. The reason for this is that, in a portion where a large amount of a bubble is confined between droplets of the curable composition, the droplets do not spread even after pressing of the mold, and this causes a defect (abnormality) due to unfilling.

However, the amount of a bubble confined between droplets of a curable composition is determined by complex actions including actions between a mold and droplets, merging of droplets, and the like. Therefore, it is impossible to keep the amount of a gas confined between the droplets equal to or smaller than a predetermined amount simply by adjusting the droplet arrangement such that the height distribution of droplets of the curable composition falls within a predetermined range.

### SUMMARY OF THE INVENTION

The present invention provides a technique advantageous in detecting an abnormality in the behavior of a curable composition in a process of forming a film of the curable composition.

According to one aspect of the present invention, there is provided a simulation method of predicting a behavior of a curable composition in a process of bringing a plurality of droplets of the curable composition arranged on a first member into contact with a second member and forming a film of the curable composition in a space between the first member and the second member, the method including for each of the plurality of droplets of the curable composition, obtaining, based on whether the droplet merges with an adjacent droplet, an evaluation value for evaluating a relationship regarding a degree of merging with the adjacent droplet, and displaying, together with information indicating a state of the droplet corresponding to the evaluation value, the evaluation value obtained in the obtaining.

Further aspects of the present invention will become apparent from the following description of exemplary embodiments with reference to the attached drawings.

### BRIEF DESCRIPTION OF THE DRAWINGS

FIG. 1 is a schematic view showing the arrangements of a film forming apparatus and a simulation apparatus according to an embodiment of the present invention.

FIG. 2 is a flowchart for describing a simulation method according to the first embodiment.

FIG. 3 is a view showing a concept of a droplet component of a curable composition.

FIG. 4 is a view for describing a process of determining whether adjacent droplet components merge with each other.

FIG. 5 is a view showing an example of calculating the behaviors of droplets of the curable composition by the simulation apparatus shown in FIG. 1.

FIG. 6 is a view showing the droplet component of the curable composition defined by 18 angles.

FIG. 7 is a view showing an example of an image displayed on a display.

FIG. 8 is a view showing an example of another image displayed on the display.

FIG. 9 is a view showing an example of still another image displayed on the display.

FIG. 10 is a flowchart for describing a simulation method according to the second embodiment.

FIG. 11 is a view for describing a link structure.

FIG. 12 is a view showing an example of an image displayed on a display.

FIG. 13 is a view showing an example of another image displayed on the display.

FIG. 14 is a view showing an example of still another image displayed on the display.

FIG. 15 is a flowchart for describing a simulation method according to the third embodiment.

FIGS. 16A and 16B are views for describing determination of the presence/absence of a closed region.

FIG. 17 is a view for describing determination of the presence/absence of a closed region.

FIGS. 18A and 18B are views for describing a method of calculating the amount of a bubble included in the closed region.

FIG. 19 is a view showing an example of an image displayed on a display.

FIG. 20 is a view showing an example of another image displayed on the display.

FIG. 21 is a graph for describing a method of detecting an abnormality in the behavior of a curable composition.

FIG. 22 is a view showing an example of still another image displayed on the display.

FIG. 23A to FIG. 23F are views for describing an article manufacturing method.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate.

Furthermore, in the attached drawings, the same reference numerals are given to the same or similar configurations, and redundant description thereof is omitted.

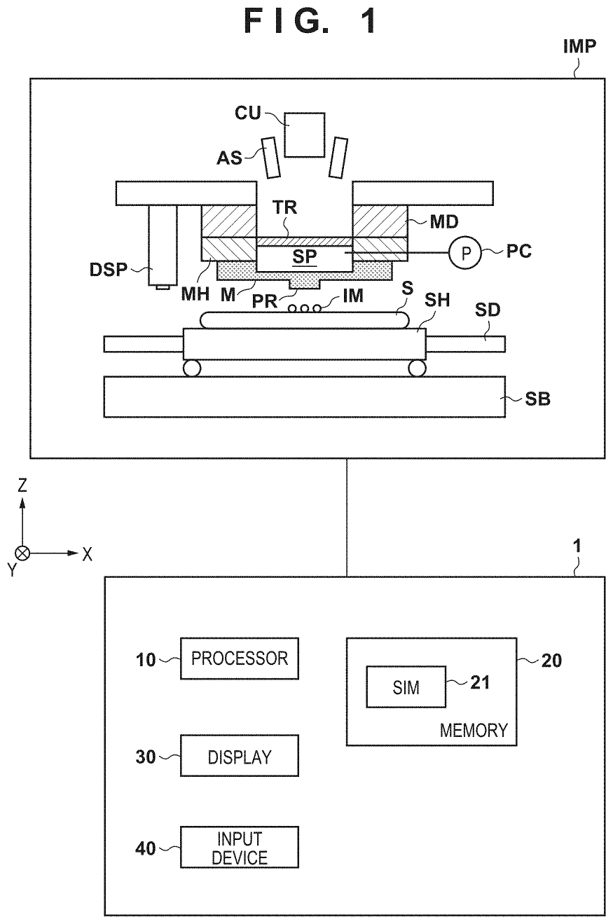

FIG. 1 is a schematic view showing the arrangements of a film forming apparatus IMP and a simulation apparatus 1 according to an embodiment of the present invention. The film forming apparatus IMP executes a process of bringing a plurality of droplets of a curable composition IM arranged on a substrate S into contact with a mold M and forming a film of the curable composition IM in a space between the substrate S and the mold M. The film forming apparatus IMP may be formed as, for example, an imprint apparatus or a planarization apparatus. The substrate S and the mold M are interchangeable, and a film of the curable composition IM may be formed in the space between the mold M and the substrate S by bringing a plurality of droplets of the curable composition IM arranged on the mold M into contact with the substrate S. Therefore, the film forming apparatus IMP is comprehensively an apparatus that executes a process of bringing a plurality of droplets of the curable composition IM arranged on the first member into contact with the second member and forming a film of the curable composition IM in a space between the first member and the second member. This embodiment provides a description by assuming the first member as the substrate S and the second member as the mold M. However, the first member may be assumed as the mold M and the second member may be assumed as the substrate S. In this case, the substrate S and the mold M in the following description are interchanged.

The imprint apparatus uses the mold M having a pattern to transfer the pattern of the mold M to the curable composition IM on the substrate S. The imprint apparatus uses the mold M having a pattern region PR provided with a pattern. As an imprint process, the imprint apparatus brings the curable composition IM on the substrate S into contact with the pattern region PR of the mold M, fills, with the curable composition IM, a space between the mold M and a region where the pattern of the substrate S is to be formed, and then cures the curable composition IM. This transfers the pattern of the pattern region PR of the mold M to the curable composition IM on the substrate S. For example, the imprint apparatus forms a pattern made of a cured product of the curable composition IM in each of a plurality of shot regions of the substrate S.

As a planarization process, using the mold M having a flat surface, the planarization apparatus brings the curable composition IM on the substrate S into contact with the flat surface of the mold M, and cures the curable composition IM, thereby forming a film having a flat upper surface. If the mold M having dimensions (size) that cover the entire region of the substrate S is used, the planarization apparatus forms a film made of a cured product of the curable composition IM on the entire region of the substrate S.

As the curable composition, a material to be cured by receiving curing energy is used. As the curing energy, an electromagnetic wave or heat can be used. The electromagnetic wave includes, for example, light selected from the wavelength range of 10 nm (inclusive) to 1 mm (inclusive) and, more specifically, infrared light, a visible light beam, or ultraviolet light. The curable composition is a composition cured by light irradiation or heating. A photo-curable composition cured by light irradiation contains at least a polymerizable compound and a photopolymerization initiator, and may further contain a nonpolymerizable compound or a solvent, as needed. The nonpolymerizable compound is at least one material selected from the group consisting of a sensitizer, a hydrogen donor, an internal mold release agent, a surfactant, an antioxidant, and a polymer component. The viscosity (the viscosity at 25° C.) of the curable composition is, for example, 1 mPa·s (inclusive) to 100 mPa·s (inclusive).

As the material of the substrate, for example, glass, a ceramic, a metal, a semiconductor, a resin, or the like is used. A member made of a material different from the substrate may be provided on the surface of the substrate, as needed. The substrate includes, for example, a silicon wafer, a compound semiconductor wafer, or silica glass.

In the specification and the accompanying drawings, directions will be indicated on an XYZ coordinate system in which directions parallel to the surface of the substrate S are defined as the X-Y plane. Directions parallel to the X-axis, the Y-axis, and the Z-axis of the XYZ coordinate system are the X direction, the Y direction, and the Z direction, respectively. A rotation about the X-axis, a rotation about the Y-axis, and a rotation about the Z-axis are θX, θY, and θZ, respectively. Control or driving concerning the X-axis, the Y-axis, and the Z-axis means control or driving concerning a direction parallel to the X-axis, a direction parallel to the Y-axis, and a direction parallel to the Z-axis, respectively. In addition, control or driving concerning the θX-axis, the θY-axis, and the θZ-axis means control or driving concerning a rotation about an axis parallel to the X-axis, a rotation about an axis parallel to the Y-axis, and a rotation about an axis parallel to the Z-axis, respectively. In addition, a position is information that is specified based on coordinates on the X-, Y-, and Z-axes, and an orientation is information that is specified by values on the θX-, θY-, and θZ-axes. Positioning means controlling the position and/or orientation.

The film forming apparatus IMP includes a substrate holder SH that holds the substrate S, a substrate driving mechanism SD that moves the substrate S by driving the substrate holder SH, and a base SB that supports the substrate driving mechanism SD. In addition, the film forming apparatus IMP includes a mold holder MH that holds the mold M and a mold driving mechanism MD that moves the mold M by driving the mold holder MH.

The substrate driving mechanism SD and the mold driving mechanism MD form a relative movement mechanism that moves at least one of the substrate S and the mold M so as to adjust the relative position between the substrate S and the mold M. Adjustment of the relative position between the substrate S and the mold M by the relative movement mechanism includes driving to bring the curable composition IM on the substrate S into contact with the mold M and driving to separate the mold M from the cured curable composition IM on the substrate S. In addition, adjustment of the relative position between the substrate S and the mold M by the relative movement mechanism includes positioning between the substrate S and the mold M. The substrate driving mechanism SD is configured to drive the substrate S with respect to a plurality of axes (for example, three axes including the X-axis, Y-axis, and θZ-axis, and preferably six axes including the X-axis, Y-axis, Z-axis, θX-axis, θY-axis, and θZ-axis). The mold driving mechanism MD is configured to drive the mold M with respect to a plurality of axes (for example, three axes including the Z-axis, θX-axis, and θY-axis, and preferably six axes including the X-axis, Y-axis, Z-axis, θX-axis, θY-axis, and θZ-axis).

The film forming apparatus IMP includes a curing unit CU for curing the curable composition IM with which the space between the substrate S and the mold M is filled. For example, the curing unit CU cures the curable composition IM on the substrate S by applying the curing energy to the curable composition IM via the mold M.

The film forming apparatus IMP includes a transmissive member TR for forming a space SP on the rear side (the opposite side of a surface opposing the substrate S) of the mold M. The transmissive member TR is made of a material that transmits the curing energy from the curing unit CU, and can apply the curing energy to the curable composition IM on the substrate S.

The film forming apparatus IMP includes a pressure control unit PC that controls deformation of the mold M in the Z-axis direction by controlling the pressure of the space SP. For example, when the pressure control unit PC makes the pressure of the space SP higher than the atmospheric pressure, the mold M is deformed in a convex shape toward the substrate S.

The film forming apparatus IMP includes a dispenser DSP for arranging, supplying, or distributing the curable composition IM on the substrate S. However, the substrate S on which the curable composition IM is arranged by another apparatus may be supplied (loaded) to the film forming apparatus IMP. In this case, the film forming apparatus IMP need not include the dispenser DSP.

The film forming apparatus IMP may include an alignment scope AS for measuring a positional shift (alignment error) between the substrate S (or the shot region of the substrate S) and the mold M.

The simulation apparatus 1 executes calculation of predicting the behavior of the curable composition IM in a process executed by the film forming apparatus IMP. More specifically, the simulation apparatus 1 executes calculation of predicting the behavior of the curable composition IM in the process of bringing the plurality of droplets of the curable composition IM arranged on the substrate S into contact with the mold M and forming a film of the curable composition IM in the space between the substrate S and the mold M.

The simulation apparatus 1 is formed by, for example, incorporating a simulation program 21 in a general-purpose or dedicated computer. Note that the simulation apparatus 1 may be formed by a PLD (Programmable Logic Device) such as an FPGA (Field Programmable Gate Array). Alternatively, the simulation apparatus 1 may be formed by an ASIC (Application Specific Integrated Circuit).

In this embodiment, the simulation apparatus 1 is formed by storing the simulation program 21 in a memory 20 in a computer including a processor 10, the memory 20, a display 30, and an input device 40. The memory 20 may be a semiconductor memory, a disk such as a hard disk, or a memory of another form. The simulation program 21 may be stored in a computer-readable memory medium or provided to the simulation apparatus 1 via a communication facility such as a telecommunication network.

A simulation method and a simulation apparatus according to the present invention relate to a process of forming a film of a curable composition in a space between a substrate and a mold, for example, simulation of the behavior of the curable composition in an imprint process. More specifically, the simulation method and the simulation apparatus according to the present invention predict, by simulating spreading of a droplet of the curable composition on the substrate including the interaction between the droplets, spreading of the droplet at an arbitrary time, and visually display it. Further, the simulation method and the simulation apparatus according to the present invention detect, from the merging state of droplets of the curable composition on the substrate and a change in the merging state, an abnormality (abnormality in spreading of the droplet) caused by a bubble confined between the droplets, and visually display it. With this, it is possible to visually check the behavior (state) of spreading of the droplet of the curable composition on the substrate, and grasp an abnormality in spreading of the droplet in advance. By adjusting the arrangement of the droplets based on the information as described above, a defect caused by unfilling can be suppressed.

A simulation method executed by the simulation apparatus 1 in each embodiment will be more specifically described below.

### First Embodiment

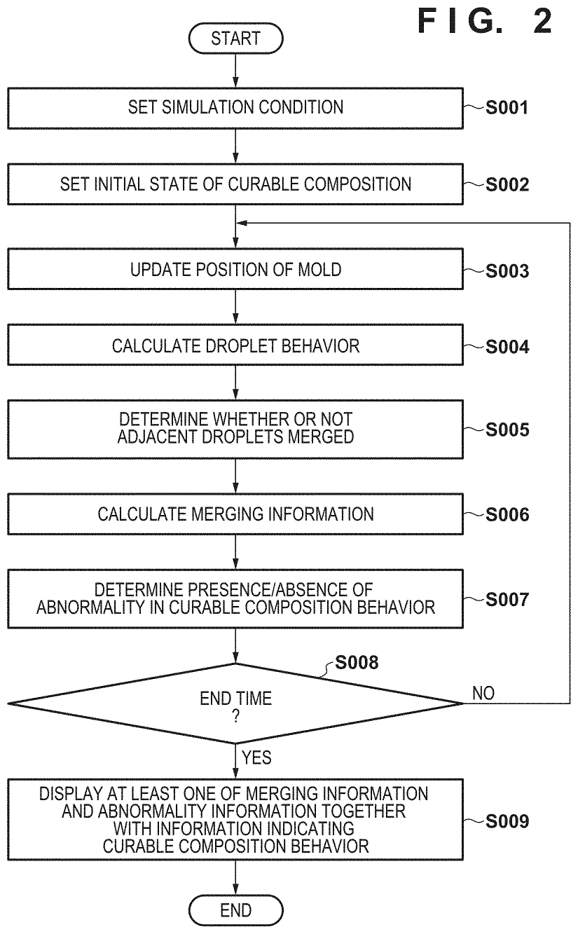

FIG. 2 is a flowchart for describing a simulation method according to the first embodiment. The simulation method includes steps S001, S002, S003, S004, S005, S006, S007, S008, and S009. A simulation apparatus 1 may be understood as an aggregate of hardware components that execute respective steps of the simulation method according to the first embodiment.

Step S001 is a step of setting a condition (simulation condition) necessary for simulation. Step S002 is a step of setting the initial state of a curable composition IM based on the simulation condition set in step S001. Steps S001 and S002 may be understood as one step obtained by combining steps S001 and S002, for example, as a preparation step. Step S003 is a step of updating (calculating) the position of a mold M (the distance between a substrate S and the mold M) by calculating the motion of the mold M. Step S004 is a step of, for each of a plurality of droplets of the curable composition IM, calculating the behavior (flow) of the droplet pressed and spread by the mold M based on the position of the mold M updated in step S003. Step S005 is a step of determining, based on the behaviors of the droplets calculated in step S004, whether adjacent droplets among the plurality of droplets of the curable composition IM merge with each other. Step S006 is a step of calculating, based on the determination in step S004 as to whether adjacent droplets merge with each other, merging information for each of the plurality of droplets of the curable composition IM. Step S007 is a step of determining, based on the merging information calculated in step S006 and the time-sequential change thereof, the presence/absence of an abnormality in the behavior of the curable composition IM (that is, detecting an abnormality in the behavior of the curable composition IM) at the corresponding time. Step S008 is a step of determining whether the time in calculation (simulation) has reached an end time. If the time in calculation has not reached the end time, the time advances to a next time, and the process shifts to step S003; otherwise, the process shifts to step S009. Step S009 is a step of displaying, together with the information indicating the states of the plurality of droplets of the curable composition IM (the behavior of the curable composition IM), at least one of the merging information calculated in step S006 and the abnormality information indicating the presence/absence of the abnormality in the behavior of the curable composition determined in step S007.

Each step of the simulation method according to the first embodiment will be described in detail below.

In step S001, various parameters are set as a condition necessary for simulation. The parameters include the arrangement of the droplets of the curable composition IM on the substrate S, the volume of each droplet, the physical properties of the curable composition IM, information concerning unevenness (for example, information of the pattern of a pattern region PR) of the surface of the mold M, and information concerning unevenness of the surface of the substrate S. The parameters include a time profile of a force applied to the mold M by a mold driving mechanism MD, and a profile of a pressure applied to a space SP (mold M) by a pressure control unit PC.

In step S002, the initial state (the state of the droplet at the start of the simulation) of each of the plurality of droplets of the curable composition IM is set. The initial state includes the contour (the shape thereof) and height of each droplet when each droplet of the curable composition IM arranged on the substrate S is wet-spread. It is possible to calculate the initial state by assuming a static balanced state using the physical properties of the curable composition IM. It is also possible to calculate the initial state from a dynamic wet spreading behavior by executing a general fluid simulation by receiving an elapsed time since arrangement of the droplet of the curable composition IM on the substrate S and the like in addition to the physical properties of the curable composition IM.

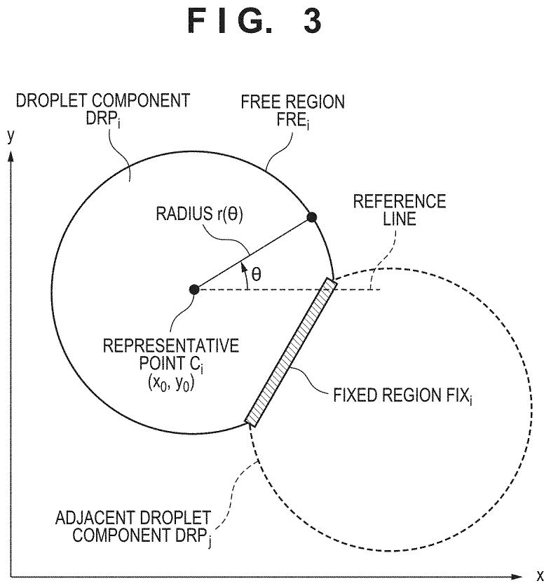

In the simulation method according to this embodiment, each droplet of the curable composition IM is modeled as a droplet component DRP, as shown in FIG. 3. FIG. 3 is a view showing a concept of the droplet component DRP of the curable composition IM. Referring to FIG. 3, DRPᵢ represents the ith droplet component in a calculation region. In the following description, a subscript i represents the number of the droplet component DRP.

A representative point is set within the droplet component of the curable composition IM. The coordinates of the representative point are represented by Ci(x0, y0). The representative point of the droplet component of the curable composition IM may be set at the barycenter of the droplet or a point (position) different from the barycenter of the droplet but needs to be set inside the contour of the droplet. Then, a distance from the representative point of the droplet component of the curable composition IM to a point on the contour (periphery) of the droplet component at a position at an angle θ (an angle formed by the reference line and a line connecting the representative point and the point on the contour of the droplet) is represented as a radius r(θ). The radius r(θ) has a different value for each angle θ. Information indicating whether each point on the contour of the droplet component merges with (intrudes inside) an adjacent droplet component is held together. The position (radius r(θ)) of the point on the contour that merges with the adjacent droplet component is fixed at this time. As indicated by hatched lines in FIG. 3, a region of the angle θ at which the radius r(θ) is fixed is set as a fixed region FIXᵢ. On the other hand, as indicated by a solid line in FIG. 3, a region of the angle θ at which the radius r(θ) is not fixed is set as a free region FREᵢ. In the initial state of the droplet of the curable composition IM, all the angles θ belong to the free region.

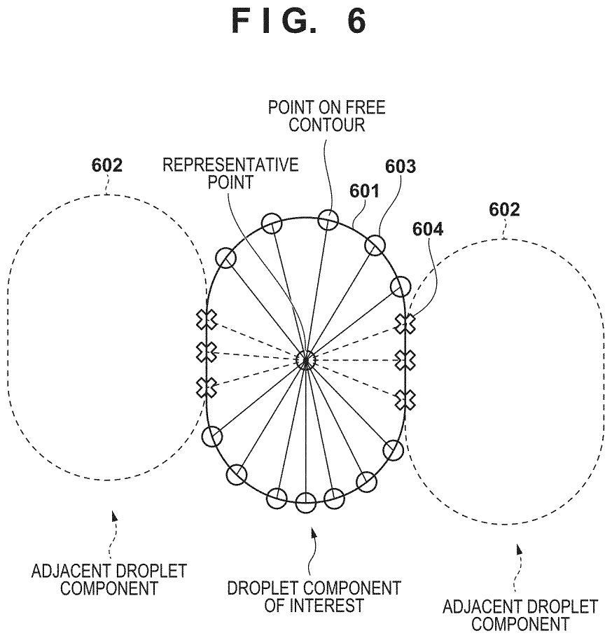

When the simulation method according to this embodiment is implemented as an actual program, it is considered that a finite number of divided angles θ are dealt with (that is, to define the contour of the droplet, the finite number of points are set on the contour of the droplet). FIG. 6 is a view showing the droplet component of the curable composition IM defined (divided) by 18 angles θ (θ1 to θ18). At this time, the angles θ may be set by equally dividing 360° or may be set to arbitrary angles. When obtaining a contour between adjacent points on the contour represented by the finite number of angles, arbitrary interpolation can be applied. For example, the adjacent points on the contour may be connected by a line or higher-order interpolation can be applied.

In step S003, the motion of the mold M is calculated and the position of the mold M is updated. The motion of the mold M is calculated by dynamics calculation in consideration of a force generated when the droplets of the curable composition IM or a liquid film in which the droplets merge with each other is crushed, a force caused by the flow of gas in the space SP between the mold M and the substrate S, a load applied to the mold M, the influence of elastic deformation of the mold M, and the like.

In step S004, the behavior of the droplet component DRP pressed and spread by the mold M is calculated. Step S004 includes a step of determining whether the droplet component DRP contacts the mold M. If a height h_{drp,i} of the droplet component DRPᵢ obtained in step S002 is compared with a distance hᵢ between the mold M and the substrate S at the representative point (x0, y0) of the droplet component DRPᵢ, and expression (1) below is satisfied, it is determined that the droplet component DRPᵢ contacts the mold M.

h_{drp,i}<hᵢ (1)

On the other hand, if expression (1) is not satisfied, it is determined that the droplet component DRPᵢ does not contact the mold M at the current time in calculation. In this case, the behavior of the droplet component DRPᵢ is not calculated.

With respect to the droplet component DRPᵢ determined to contact the mold M, a behavior of being pressed and spread by the motion of the mold M is calculated. In this step, the volume of the droplet of the curable composition IM is saved (maintained). Therefore, an area S^{new} of the droplet component DRPᵢ at the current time can be represented using a volume Vᵢ of the droplet component DRPᵢ and the distance hᵢ at the droplet component position at the current time by:

$${S}^{n e w} = \frac{{V}_{i}}{{h}_{i}} \qquad ( 2 )$$

In step S005, it is determined whether the adjacent droplet components merge with each other. As a result of calculating the contour of the droplet component in step S004, a point on the contour of the angle θ belonging to the free region FRE falls within the adjacent droplet component (inside the contour). In this case, the radius r(θ) at the angle θ is fixed (that is, the distance, from the representative point to the point on the contour, corresponding to the merging portion of the droplet is fixed). In other words, the angle θ is included in the fixed region FIX, and after this time, the droplet component of the curable composition IM does not spread (flow) in the direction of the angle θ. In step S005, for all the pairs of adjacent droplet components, it is determined whether the droplets merge with each other, as described above.

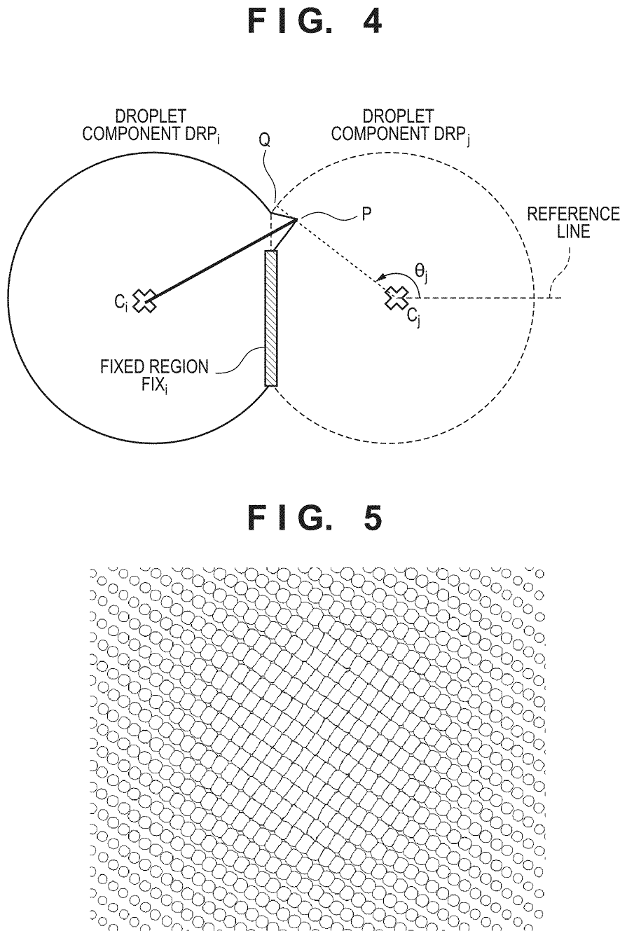

A process of determining whether the adjacent droplet components merge with each other, that is, whether a point on the contour of the droplet is located inside the contour of the adjacent droplet will be described with reference to FIG. 4. Consider a point P on a contour in an angle direction belonging to the free region FRE of the droplet component DRPᵢ by paying attention to the droplet component DRPᵢ. A droplet component adjacent to the droplet component DRPᵢ is set as a droplet component DRPᵢ and then the length of a line segment PCⱼ connecting the point P and a representative point Cⱼ (center) of the droplet component DRP is obtained. Furthermore, an angle θⱼ formed by the line segment PCⱼ and the reference line of the droplet component is obtained, and then the length of a radius QCⱼ of the droplet component DRP at the angle θⱼ is obtained. If the length of the radius QCⱼ is compared with that of the line segment PCⱼ, and the length of the radius QCⱼ is longer than that of the line segment PCⱼ, it is determined that the point P on the contour of the droplet component DRPᵢ is located inside the contour of the adjacent droplet component DRPᵢ that is, the droplet components merge with each other. On the other hand, if the length of the radius QCⱼ is shorter than that of the line segment PCⱼ, it is determined that the point P on the contour of the droplet component DRPᵢ is not located inside the contour of the adjacent droplet component DRPᵢ that is, the droplet components do not merge with each other. Note that FIG. 4 shows a state in which the point P on the contour of the droplet component DRPᵢ largely intrudes inside the adjacent droplet component DRPⱼ. This emphasizes the feature of this embodiment. In actual calculation, by making a time interval sufficiently short, an intrusion amount by which the point P on the contour of the droplet component DRPᵢ intrudes inside the adjacent droplet component DRP can be decreased to a negligible amount.

FIG. 5 is a view showing an example of calculating the behaviors (spreading) of the droplets of the curable composition IM by the simulation apparatus 1 implementing the simulation method according to this embodiment. The distance between the mold M and the substrate S is shorter toward the center of FIG. 5, and is longer away from the center of FIG. 5. Referring to FIG. 5, it is apparent that the state of complicated merging of the droplets and the like can be represented in accordance with the arrangement of the droplets of the curable composition IM on the substrate S.

In step S006, based on the determination as to whether the adjacent droplet components merge with each other, merging information is calculated. The merging information means an evaluation value for evaluating the relationship regarding the degree of merging with adjacent droplets. For example, in this embodiment, the information indicating the part of the contour of each droplet of the curable composition IM contacting the contour of another droplet is used as the merging information. More specifically, the ratio of the part determined to contact another droplet to the contour length of the droplet of the curable composition IM, that is, the ratio of the part contacting the contour of the adjacent droplet to the whole circumference of the contour of the droplet is used as the merging information. At this time, the contour of the droplet of the curable composition IM may be divided by a plurality of angles, and the ratio of the angles determined to contact another droplet may be used as the merging information.

With reference to FIG. 6, the merging ratio with adjacent droplets with respect to the contour length of a droplet component of the curable composition IM, that is, the outline of the merging information in this embodiment will be described. In FIG. 6, reference numeral 601 indicates the contour of a droplet component of interest, and reference numeral 602 indicates the contour of a droplet component adjacent to the droplet component of interest. The contour 601 of the droplet component of interest is sampled at a plurality of points 603, and for each of the plurality of points 603, it is determined whether the point 603 contacts the contour of 602 of the adjacent droplet component. For example, among the plurality of points 603, a point 604 is a point determined to contact the contour of 602 of the adjacent droplet component. Finally, the ratio of the number of the points 604 contacting the contour of 602 of the adjacent droplet component to the total number of the sampling points 603 of the contour 601 of the droplet component of interest is used as the merging information.

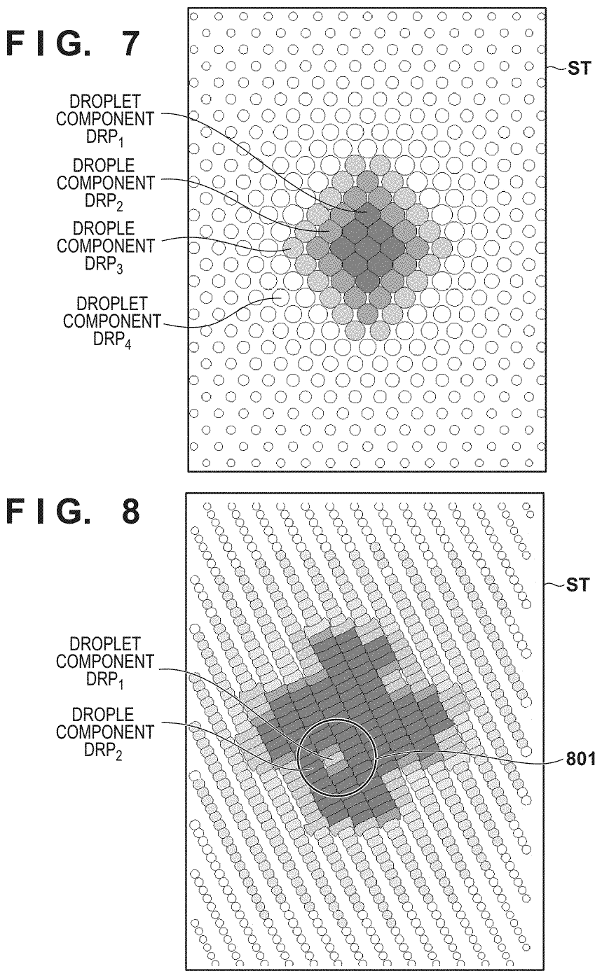

The merging information obtained as described above is displayed in step S009 on a display 30 together with information indicating the state (spreading state) of the droplet of the curable composition IM corresponding to the merging information. FIG. 7 is a view showing an example of an image including the merging information displayed on the display 30 in step S009. In FIG. 7, the merging information is displayed in color with respect to the distribution of the droplet components DRPᵢ arranged in a shot region ST of the substrate S. In this embodiment, for each droplet component DRPᵢ, the color in the region of the droplet component DRPᵢ is changed in accordance with the ratio of the merging part with adjacent droplets to the contour length of the droplet.

Consider a case in which, when bringing the mold M into contact with the curable composition IM on the substrate S, the mold M is deformed in a convex shape toward the substrate S. In this case, from the droplet components DRPᵢ arranged in the center of the shot region ST toward the droplet components DRPᵢ arranged on the outer side in the shot region ST, the droplet components DRPᵢ are sequentially pressed and spread. Accordingly, the droplet component DRPᵢ arranged in the center of the shot region ST tends to have a higher merging ratio with adjacent droplets than the droplet component DRPᵢ arranged on the outer side in the shot region ST. In FIG. 7, for each droplet component DRPᵢ, the density in the region of the droplet component DRPᵢ is changed in accordance with the merging ratio with adjacent droplets. The region of the droplet component DRPᵢ having a higher merging ratio with adjacent droplets is displayed in a darker color. More specifically, in the order of a droplet component DRPᵢ, a droplet component DRP₂, and a droplet component DRP₃, that is, in the order of the distance from the center of the shot region ST, the region of the droplet component is displayed in a brighter color. Like a droplet component DRP₄, if the droplet component does not contact the adjacent droplet, its region is displayed in white color. Note that by displaying the region of the droplet component DRPᵢ and the contour of the droplet component DRPᵢ in different colors so as to be discriminated (distinguishably) from each other, the boundary with the adjacent droplet can also be checked.

In this embodiment, a case has been described in which, in accordance with the magnitude of the merging information, the density in the region of the droplet corresponding to the merging information is changed, but the present invention is not limited to this. For example, in accordance with the magnitude of the merging information, the hue in the region of the droplet corresponding to the merging information may be changed. Further, by displaying a general example associating the color representing the magnitude of the merging information and the magnitude relationship of the merging information indicated by the color (in this embodiment, the merging ratio with adjacent droplets), the merging information can be numerically grasped. Thus, for each of the plurality of droplets of the curable composition IM, the contact state of the droplet, which is the spreading state of the droplet, can be visually grasped.

In step S007, based on the merging information calculated in step S006 and the time-sequential change thereof, the presence/absence of an abnormality in the behavior of the curable composition IM at the corresponding time is determined (that is, an abnormality in the behavior of the curable composition IM is detected). Normally, when the contact between the curable composition IM on the substrate S and the mold M progresses, the merging ratio with adjacent droplets increases from the droplet component DRPᵢ arranged near the center of the shot region ST, and gradually increases toward the droplet component DRPᵢ arranged in the periphery of the shot region ST. On the other hand, if an abnormality has occurred in the behavior of the curable composition IM, the droplet component DRPᵢ having a smaller merging ratio with adjacent droplets than the surrounding droplet component DRPᵢ exists among the droplet components DRPᵢ arranged near the center of the shot region ST.

FIG. 8 is a view showing an example of an image including the merging information displayed on the display 30 in step S009 when an abnormality has occurred in the behavior of the curable composition IM. In FIG. 8, the merging information is displayed in color with respect to the distribution of the droplet components DRPᵢ arranged in the shot region ST of the substrate S. In this embodiment, for each droplet component DRPᵢ, the color in the region of the droplet component DRPᵢ is changed in accordance with the ratio of the merging part with adjacent droplets to the contour length of the droplet. In FIG. 8, the region of the droplet component DRPᵢ having a higher merging ratio with adjacent droplets is displayed in a darker color.

Normally, the droplet component DRPᵢ arranged near the center of the shot region ST has a higher merging ratio with adjacent droplets and its region is displayed in a darker color than the droplet component DRPᵢ arranged away from the center of the shot region ST. However, in FIG. 8, the region of the droplet component DRPᵢ arranged near the center of the shot region ST is displayed in a brighter color than the region of the surrounding droplet components. More specifically, the region of the droplet component DRP₂ arranged on the outer side of the droplet component DRPᵢ in the shot region ST is displayed in a darker color than the region of the droplet component DRPᵢ. From this, it is apparent that an abnormality has occurred in the behavior of the droplet component DRPᵢ.

An example of a method of detecting an abnormality in the behavior of the curable composition IM will be described below. This is a method of searching for the droplet, that is surrounded by droplets whose entire contours merge with adjacent droplets, and includes a part of the contour not merging with adjacent droplets, and detecting such the droplet as the droplet where an abnormality has occurred. More specifically, the droplet having a lower merging ratio with adjacent droplets than surrounding droplets is detected as the droplet where an abnormality has occurred. In this embodiment, the presence/absence of an abnormality is determined (an abnormality is detected) by following the procedure including (1), (2), and (3) below. Note that the merging information of the droplet in a state in which the entire contour does not merge with adjacent droplets is indicated by 0, the merging information of the droplet in a state in which the entire contour merges with adjacent droplets is indicated by 1, and the merging information of the droplet in a state in which a part of the contour merges with adjacent droplets is indicated by a value between 0 and 1.

(1) From all the droplets, the droplet where a part of the contour does not merge with adjacent droplets, that is, the droplet with the merging information other than 1 is extracted, and the extracted droplet is considered to be included in a droplet group DG1 (for example, the droplet component DRPᵢ shown in FIG. 8).

(2) From all the droplets included in the droplet group DG1, the droplet whose representative point falls within a range of a preset distance D from the representative point of the droplet included in the droplet group DG1 is extracted, and the extracted droplet is considered to be included in a droplet group DG2 (for example, the droplet component DRP₂ shown in FIG. 8). In FIG. 8, reference numeral 801 indicates the range of the distance D from the droplet component DRP₁, that is, the droplet extraction range.

(3) For each of all the droplets included in the droplet group DG1, in a case in which all the droplets included in each droplet group DG2 are in the state in which the entire contour merges with the adjacent droplets (the merging information is 1), it is determined that an abnormality has occurred. Also in a case in which the droplet included in each droplet group DG2 has the larger merging information than the droplet included in the droplet group DG1, it is determined that an abnormality has occurred.

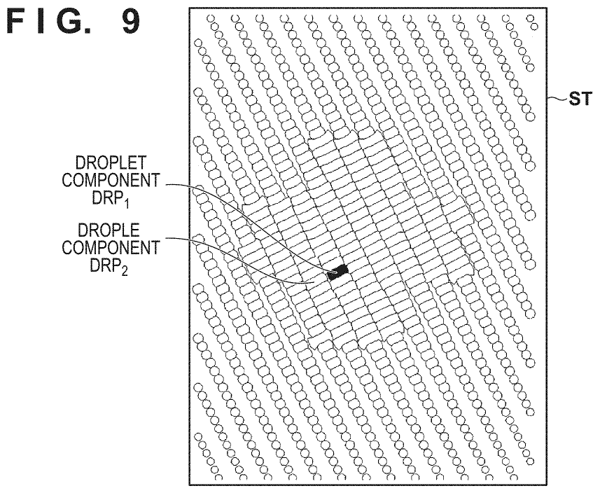

The abnormality in the behavior of the curable composition IM detected as described above is displayed in step S009 on the display 30 as the abnormality information indicating the presence/absence of the abnormality in the behavior of the curable composition IM together with the information indicating the states (spreading states) of the droplets of the curable composition IM. FIG. 9 is a view showing an example of an image including the abnormality information displayed on the display 30 in step S009. In FIG. 9, for each droplet component DRPᵢ shown in FIG. 8, it is determined whether an abnormality has occurred, and the region of the droplet component DRPᵢ determined to be abnormal is displayed in black color. Alternatively, the droplet component DRPᵢ determined to be abnormal is displayed in color different from the color for the droplet determined to be normal (determined not to be abnormal), for example, the droplet component DRP₂. In this manner, by displaying the droplet determined to be abnormal and the droplet determined to be normal in different colors so as to be discriminated (distinguishably) from each other, the presence/absence of the abnormality can be visually grasped. Alternatively, the droplet determined to be abnormal and the droplet determined to be normal may be displayed in different display modes. For example, the droplet determined to be abnormal may be blinked, and the droplet determined to be normal may not be blinked.

The calculation step including steps S003, S004, S005, S006, and S007 is executed for a plurality of preset times. For example, the plurality of times are arbitrarily set within a period from a time when the mold M starts to lower from the initial position until a time when the mold M contacts a plurality of droplets, the plurality of droplets are crushed to spread, and merge with each other to finally form one film, and the curable composition should be cured. The plurality of times are typically set at a predetermined time interval.

In step S008, it is determined whether the time in calculation has reached the end time. As described above, if the time in calculation has not reached the end time, the time advances to the next time, and the process shifts to step S003; otherwise, the process shifts to step S009. In an example, in step S008, the current time is advanced by a designated time step, thereby setting a new time. Then, if the new time has reached the end time, the process shifts to step S009.

As has been described above, in step S009, at least one of the image shown in FIG. 7, the image shown in FIG. 8, and the image shown in FIG. 9 is displayed on the display 30. In step S009, for example, in accordance with a user request, the image shown in FIG. 7, the image shown in FIG. 8, and the image shown in FIG. 9 may be switched and displayed, or some or all of the image shown in FIG. 7, the image shown in FIG. 8, and the image shown in FIG. 9 may be displayed.

According to this embodiment, it becomes possible to determine the presence/absence of an abnormality in the behavior of each of the plurality of droplets of the curable composition IM arranged on the substrate S, particularly, in spreading of the droplet, and visually recognize it. Therefore, it is possible to provide a technique advantageous in detecting an abnormality in the behavior of the curable composition IM in the process of forming a film of the curable composition IM in a film forming apparatus IMP. Further, by repeatedly adjusting the arrangement pattern of the droplets of the curable composition IM using the simulation method according to this embodiment and the results obtained thereby, it becomes possible to readily set a condition for the process of forming a film of the curable composition IM while reducing abnormalities in the process.

### Second Embodiment

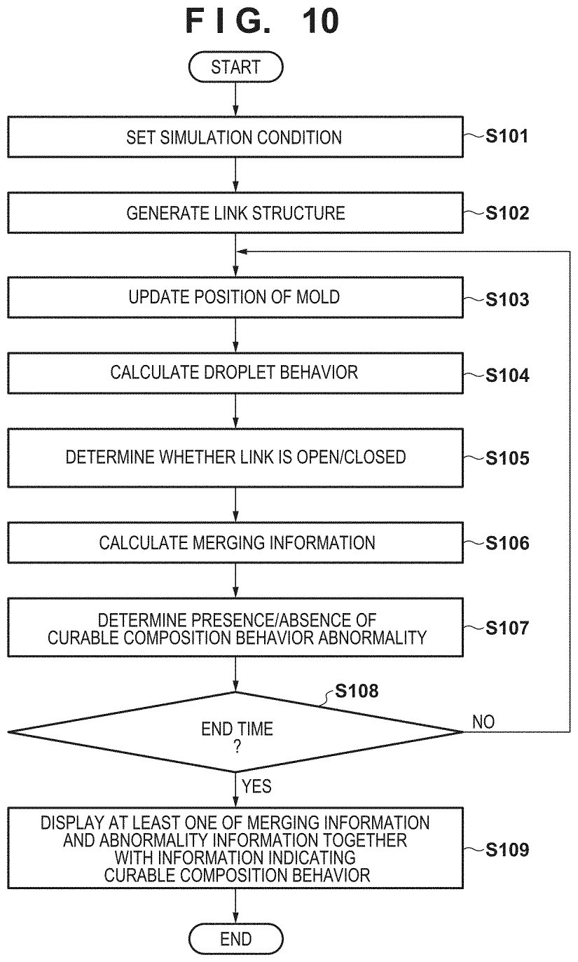

FIG. 10 is a flowchart for describing a simulation method according to the second embodiment. The simulation method includes steps S101, S102, S103, S104, S105, S106, S107, S108, and S109. A simulation apparatus 1 may be understood as an aggregate of hardware components that execute respective steps of the simulation method according to the second embodiment.

Step S101 is a step of setting a condition (simulation condition) necessary for simulation. Step S102 is a step of generating a link structure connecting adjacent droplets based on the arrangement information of droplets of a curable composition IM set in step S101. Steps S101 and S102 may be understood as one step obtained by combining steps S101 and S102, for example, as a preparation step. Step S103 is a step of updating the position of a mold M by calculating the motion of the mold M. Step S104 is a step of, for each of a plurality of droplets of the curable composition IM, calculating the behavior of the droplet pressed and spread by the mold M based on the position of the mold M updated in step S103. Step S105 is a step of determining whether each link of the link structure generated in step S102 is closed, that is, determining whether the link is open or closed. Step S106 is a step of calculating, based on the determination in step S105 as to whether each link of the link structure is closed, merging information for each of the plurality of droplets of the curable composition IM. Step S107 is a step of determining, based on the merging information calculated in step S106 and the time-sequential change thereof, the presence/absence of an abnormality in the behavior of the curable composition IM (that is, detecting an abnormality in the behavior of the curable composition IM) at the corresponding time. Step S108 is a step of determining whether the time in calculation (simulation) has reached an end time. If the time in calculation has not reached the end time, the time advances to a next time, and the process shifts to step S103; otherwise, the process shifts to step S109. Step S109 is a step of displaying, together with the information indicating the states of the plurality of droplets of the curable composition IM (the behavior of the curable composition IM), at least one of the merging information calculated in step S106 and the abnormality information indicating the presence/absence of the abnormality in the behavior of the curable composition determined in step S107.

Each step of the simulation method according to the second embodiment will be described in detail below. Note that steps S101, S103, and S104 are similar to steps S001, S003, and S004 shown in FIG. 2, respectively, and a detailed description thereof will be omitted here.

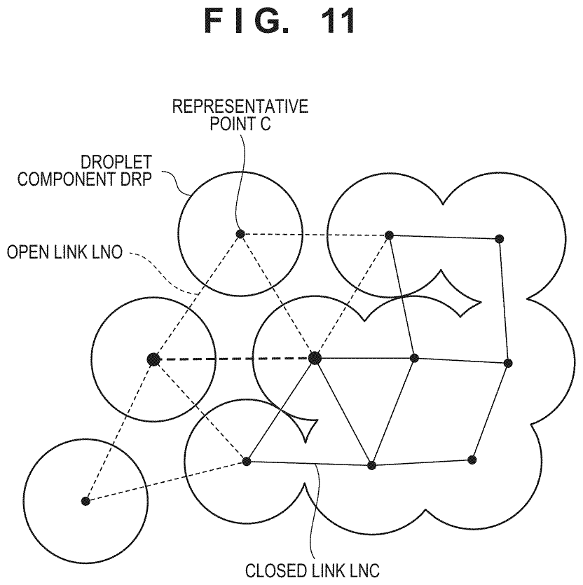

In step S102, a link structure connecting adjacent droplets is generated based on the arrangement information of droplets of the curable composition IM. With reference to FIG. 11, the link structure will be described. Each droplet of the curable composition IM is modeled as a droplet component DRP as shown in FIG. 11. Referring to FIG. 11, a node ND is generated at a representative point C of the droplet component DRPᵢ and a link is generated by connecting adjacent nodes. More specifically, the link is generated between the nodes generated in the droplet components existing near the portion where merging of the droplets of the curable composition IM occurs, and defined as a line segment connecting the two nodes. If two droplet components forming the link merge with each other, the link is referred to as a closed link LNC. If two droplet components forming the link do not merge with each other, the link is referred to as an open link LNO. Note that when the link is described without discriminating the closed link and the open link, the link is referred to as a link LN. The link is generated such that the links always intersect with each other at the node, and never intersect with each other at a portion other than the node (that is, the link is generated only between the adjacent droplet components). As a method of generating such a link structure, for example, a method using Deloney division method or the like is used.

In step S105, for all the links LN, opening/closing of the link is determined. In this embodiment, in each link LN, if the droplet components forming the link LN do not merge with each other, the link is determined to be the open link LNO. If the droplet components forming the link LN merge with each other, the link LN is determined to be the closed link LNC. In order to determine whether the adjacent droplet components merge with each other, the process of determining whether a point on the contour of the droplet is located inside the contour of the adjacent droplet may be used as described with reference to FIG. 4. More specifically, as shown in FIG. 4, if the length of a radius QCⱼ is compared with that of a line segment PCⱼ, and the length of the radius QCⱼ is longer than that of the line segment PCⱼ, it is determined that the link LN is closed. On the other hand, if the length of the radius QCⱼ is compared with that of the line segment PCⱼ, and the length of the radius QCⱼ is shorter than that of the line segment PCⱼ, it is determined that the link LN is open.

In step S106, mering information is calculated using the determination result as to opening/closing of the link LN. The merging information means an evaluation value for evaluating the relationship regarding the degree of merging with adjacent droplets. For example, in this embodiment, the information indicating the number of closed links among the links of each droplet of the curable composition IM is used as the merging information. More specifically, the ratio of the closed links LNC to the links LN generated for the droplet component DRP is used as the merging information.

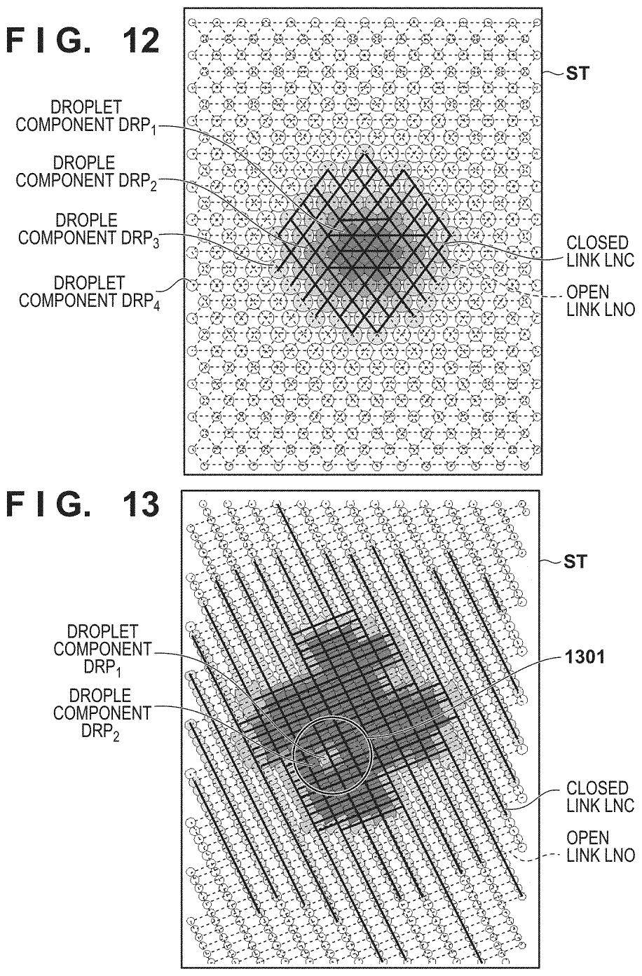

The merging information obtained as described above is displayed in step S109 on a display 30 together with information indicating the state (spreading state) of the droplet of the curable composition IM corresponding to the merging information. FIG. 12 is a view showing an example of an image including the merging information displayed on the display 30 in step S109. In FIG. 12, the merging information is displayed in color with respect to the distribution of droplet components DRPᵢ arranged in a shot region ST of a substrate S. Further, in FIG. 12, for each droplet component DRPᵢ, among the links LN whose nodes are located at the droplet component DRPᵢ, the closed link LNC is indicated by a solid line, and the open link LNO is indicated by a dashed line. In this embodiment, for each droplet component DRPᵢ, the color in the region of the droplet component DRPᵢ is changed in accordance with the ratio of the closed links LNC.

Consider a case in which, when bringing the mold M into contact with the curable composition IM on the substrate S, the mold M is deformed in a convex shape toward the substrate S. In this case, from the droplet components DRPᵢ arranged in the center of the shot region ST toward the droplet components DRPᵢ arranged on the outer side in the shot region ST, the droplet components DRPᵢ are sequentially pressed and spread. Accordingly, the droplet component DRPᵢ arranged in the center of the shot region ST tends to have a higher ratio of the closed links LNC than the droplet component DRPᵢ arranged on the outer side in the shot region ST. In FIG. 12, for each droplet component DRP₁, the density in the region of the droplet component DRPᵢ is changed in accordance with the ratio of the closed links LNC. The region of the droplet component DRPᵢ having a higher ratio of the closed links LNC is displayed in a darker color. More specifically, in the order of a droplet component DRP₁, a droplet component DRP₂, and a droplet component DRP₃, that is, in the order of the distance from the center of the shot region ST, the region of the droplet component is displayed in a brighter color. Like a droplet component DRP₄, if the droplet component does not contact the adjacent droplet, that is, if the ratio of the closed links LNC is 0, its region is displayed in white color. Note that by displaying the region of the droplet component DRPᵢ and the contour of the droplet component DRPᵢ in different colors so as to be discriminated (distinguishably) from each other, the boundary with the adjacent droplet can also be checked.

In this embodiment, a case has been described in which, in accordance with the magnitude of the merging information, the density in the region of the droplet corresponding to the merging information is changed, but the present invention is not limited to this. For example, in accordance with the magnitude of the merging information, the hue in the region of the droplet corresponding to the merging information may be changed. Further, by displaying a general example associating the color representing the magnitude of the merging information and the magnitude relationship of the merging information indicated by the color (in this embodiment, the ratio of the closed links LNC), the merging information can be numerically grasped. Thus, for each of the plurality of droplets of the curable composition IM, the contact state of the droplet, which is the spreading state of the droplet, can be visually grasped. In addition, since the closed link LNC is indicated by the solid line and the open link LNO is indicated by the dashed line in FIG. 12, it is possible to visually grasp the presence/absence of merging between the droplets.

In step S107, based on the merging information calculated in step S106 and the time-sequential change thereof, the presence/absence of an abnormality in the behavior of the curable composition IM at the corresponding time is determined (that is, an abnormality in the behavior of the curable composition IM is detected). Normally, when the contact between the curable composition IM on the substrate S and the mold M progresses, the ratio of the closed links LNC increases from the droplet component DRPᵢ arranged near the center of the shot region ST, and gradually increases toward the droplet component DRPᵢ arranged in the periphery of the shot region ST. On the other hand, if an abnormality has occurred in the behavior of the curable composition IM, the droplet component DRPᵢ having a lower ratio of the closed links LNC than the surrounding droplet component DRPᵢ exists among the droplet components DRPᵢ arranged near the center of the shot region ST.

FIG. 13 is a view showing an example of an image including the merging information displayed on the display 30 in step S109 when an abnormality has occurred in the behavior of the curable composition IM. In FIG. 13, the merging information is displayed in color with respect to the distribution of the droplet components DRPᵢ arranged in the shot region ST of the substrate S. In this embodiment, for each droplet component DRPᵢ, the color in the region of the droplet component DRPᵢ is changed in accordance with the ratio of the closed links LNC. In FIG. 13, the region of the droplet component DRPᵢ having a higher ratio of the closed links LNC is displayed in a darker color.

Normally, the droplet component DRPᵢ arranged near the center of the shot region ST has a higher ratio of the closed links LNC and its region is displayed in a darker color than the droplet component DRPᵢ arranged away from the center of the shot region ST. However, in FIG. 13, the region of the droplet component DRPᵢ arranged near the center of the shot region ST is displayed in a brighter color than the region of the surrounding droplet component. More specifically, the region of the droplet component DRP₂ arranged on the outer side of the droplet component DRPᵢ in the shot region ST is displayed in a darker color than the region of the droplet component DRP₁. From this, it is apparent that an abnormality has occurred in the behavior of the droplet component DRP₁.

An example of a method of detecting an abnormality in the behavior of the curable composition IM will be described below. This is a method of searching for the droplet, that is surrounded by the droplets where all the links LN are the closed links LNC, and includes the open link LNO among the links LN, and detecting such the droplet as the droplet where an abnormality has occurred. In this embodiment, the presence/absence of an abnormality is determined (an abnormality is detected) by following the procedure including (1), (2), and (3) below. Note that the merging information of the droplet where all the links LN are the open links LNO is indicated by 0, the merging information of the droplet where all the links LN are the closed links LNC is indicated by 1, and the merging information of the droplet where some links LN are the closed links LNC is indicated by a value between 0 and 1 in accordance with the ratio of the closed links LNC.

(1) From all the droplets, the droplet including the open link LNO, that is, the droplet with the merging information other than 1 is extracted, and the extracted droplet is considered to be included in a droplet group DG1 (for example, the droplet component DRPᵢ shown in FIG. 13).

(2) From all the droplets included in the droplet group DG1, the droplet whose representative point falls within a range of a preset distance D from the representative point of the droplet included in the droplet group DG1 is extracted, and the extracted droplet is considered to be included in a droplet group DG2 (for example, the droplet component DRP₂ shown in FIG. 13). In FIG. 13, reference numeral 1301 indicates the range of the distance D from the droplet component DRP₁, that is, the droplet extraction range.

(3) In a case in which all the links LN, whose nodes are located at all the droplets included in each droplet group DG2, are the closed links LNC (the merging information is 1), it is determined that an abnormality has occurred. Also in a case in which the droplet included in each droplet group DG2 has the larger merging information that the droplet included in the droplet group DG1, it is determined that an abnormality has occurred.

The abnormality in the behavior of the curable composition IM detected as described above is displayed in step S109 on the display 30 as the abnormality information indicating the presence/absence of the abnormality in the behavior of the curable composition IM together with the information indicating the states (spreading states) of the droplets of the curable composition IM. FIG. 14 is a view showing an example of an image including the abnormality information displayed on the display 30 in step S109. In FIG. 14, for each droplet component DRPᵢ shown in FIG. 13, it is determined whether an abnormality has occurred, and the region of the droplet component DRPᵢ determined to be abnormal is displayed in black color. Alternatively, the droplet component DRPᵢ determined to be abnormal is displayed in color different from the color for the droplet determined to be normal (determined not to be abnormal), for example, the droplet component DRP₂. In this manner, by displaying the droplet determined to be abnormal and the droplet determined to be normal in different colors so as to be discriminated (distinguishably) from each other, the presence/absence of the abnormality can be visually grasped. Alternatively, the droplet determined to be abnormal and the droplet determined to be normal may be displayed in different display modes. For example, the droplet determined to be abnormal may be blinked, and the droplet determined to be normal may not be blinked. Note that since the closed link LNC is indicated by a solid line and the open link LNO is indicated by a dashed line in FIG. 14, it is possible to visually grasp the presence/absence of merging between the droplets in the portion where the abnormality has occurred.

The calculation step including steps S103, S104, S105, S106, and S107 is executed for a plurality of preset times. For example, the plurality of times are arbitrarily set within a period from a time when the mold M starts to lower from the initial position until a time when the mold M contacts a plurality of droplets, the plurality of droplets are crushed to spread, and merge with each other to finally form one film, and the curable composition should be cured. The plurality of times are typically set at a predetermined time interval.

In step S108, it is determined whether the time in calculation has reached the end time. As described above, if the time in calculation has not reached the end time, the time advances to the next time, and the process shifts to step S103; otherwise, the process shifts to step S109. In an example, in step S108, the current time is advanced by a designated time step, thereby setting a new time. Then, if the new time has reached the end time, the process shifts to step S109.

As has been described above, in step S109, at least one of the image shown in FIG. 12, the image shown in FIG. 13, and the image shown in FIG. 14 is displayed on the display 30. In step S109, for example, in accordance with a user request, the image shown in FIG. 12, the image shown in FIG. 13, and the image shown in FIG. 14 may be switched and displayed, or some or all of the image shown in FIG. 12, the image shown in FIG. 13, and the image shown in FIG. 14 may be displayed.

According to this embodiment, it becomes possible to determine the presence/absence of an abnormality in the behavior of each of the plurality of droplets of the curable composition IM arranged on the substrate S, particularly, in spreading of the droplet, and visually recognize it. Therefore, it is possible to provide a technique advantageous in detecting an abnormality in the behavior of the curable composition IM in the process of forming a film of the curable composition IM in a film forming apparatus IMP. Further, by repeatedly adjusting the arrangement pattern of the droplets of the curable composition IM using the simulation method according to this embodiment and the results obtained thereby, it becomes possible to readily set a condition for the process of forming a film of the curable composition IM while reducing abnormalities in the process.

### Third Embodiment

FIG. 15 is a flowchart for describing a simulation method according to the third embodiment. The simulation method includes steps S201, S202, S203, S204, S205, S206, S207, S208, S209, and S210. A simulation apparatus 1 may be understood as an aggregate of hardware components that execute respective steps of the simulation method according to the third embodiment.

Step S201 is a step of setting a condition (simulation condition) necessary for simulation. Step S202 is a step of generating a link structure connecting adjacent droplets based on the arrangement information of droplets of a curable composition IM set in step S201. Steps S201 and S202 may be understood as one step obtained by combining steps S201 and S202, for example, as a preparation step. Step S203 is a step of updating the position of a mold M by calculating the motion of the mold M. Step S204 is a step of, for each of a plurality of droplets of the curable composition IM, calculating the behavior of the droplet pressed and spread by the mold M based on the position of the mold M updated in step S203. Step S205 is a step of determining whether each link of the link structure generated in step S202 is closed, that is, determining opening/closing of the link. In step S206, the presence/absence of a closed region, which is formed by adjacent droplets when pressed and spread droplets merge with each other, is determined. Step S207 is a step of calculating, based on the determination result in step S205 and the determination result in step S206, merging information for each of the plurality of droplets of the curable composition IM. Step S208 is a step of determining, based on the merging information calculated in step S207 and the time-sequential change thereof, the presence/absence of an abnormality in the behavior of the curable composition IM (that is, detecting an abnormality in the behavior of the curable composition IM) at the corresponding time. Step S209 is a step of determining whether the time in calculation (simulation) has reached an end time. If the time in calculation has not reached the end time, the time advances to a next time, and the process shifts to step S203; otherwise, the process shifts to step S210. Step S210 is a step of displaying, together with the information indicating the states of the plurality of droplets of the curable composition IM (the behavior of the curable composition IM), at least one of the merging information calculated in step S207 and the abnormality information indicating the presence/absence of the abnormality in the behavior of the curable composition determined in step S208.

Each step of the simulation method according to the third embodiment will be described in detail below. Note that steps S201, S202, S203, S204, and S205 are similar to S101, S102, S103, S104, and S105 shown in FIG. 10, respectively, and a detailed description thereof will be omitted here. Each droplet of the curable composition IM is modeled as a droplet component DRP.

In step S206, the presence/absence of a closed region formed by adjacent droplets is determined. The presence/absence of a closed region is determined by referring to the determination in step S205 as to whether each link of the link structure is closed, and determining whether the closed links adjacent to each other are connected and form a closed figure (ring).

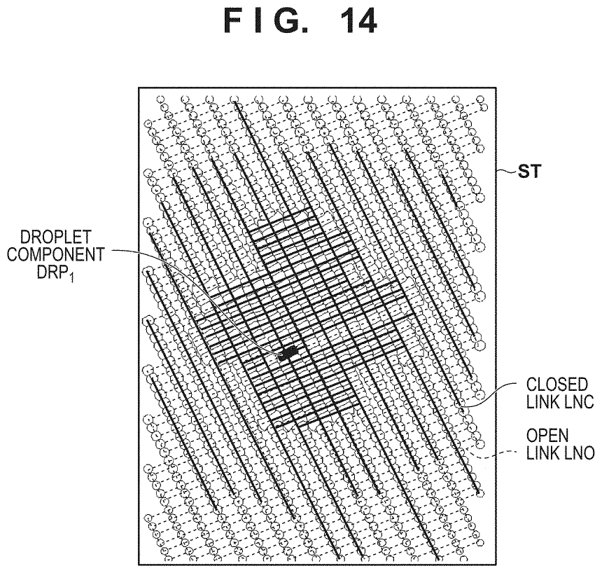

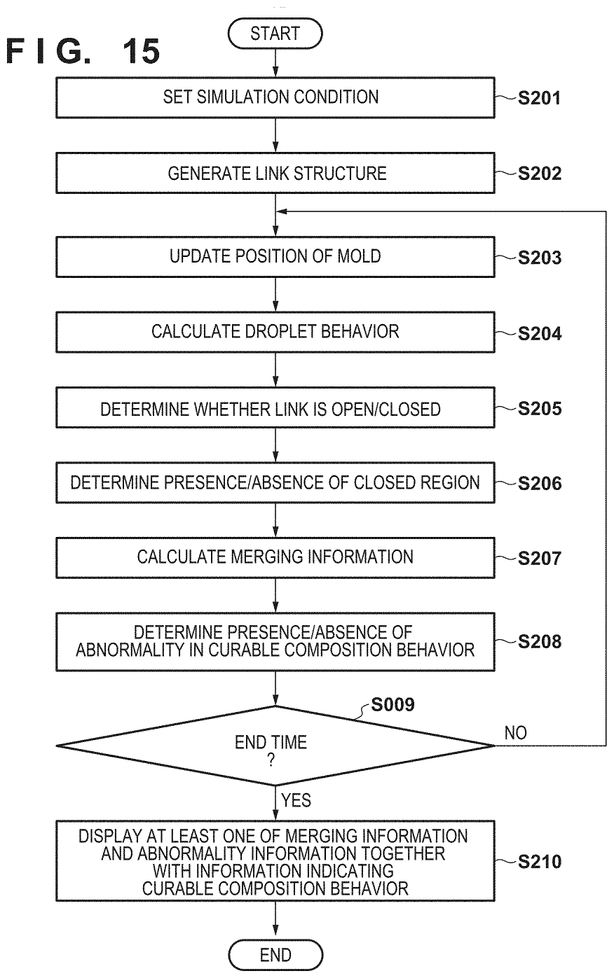

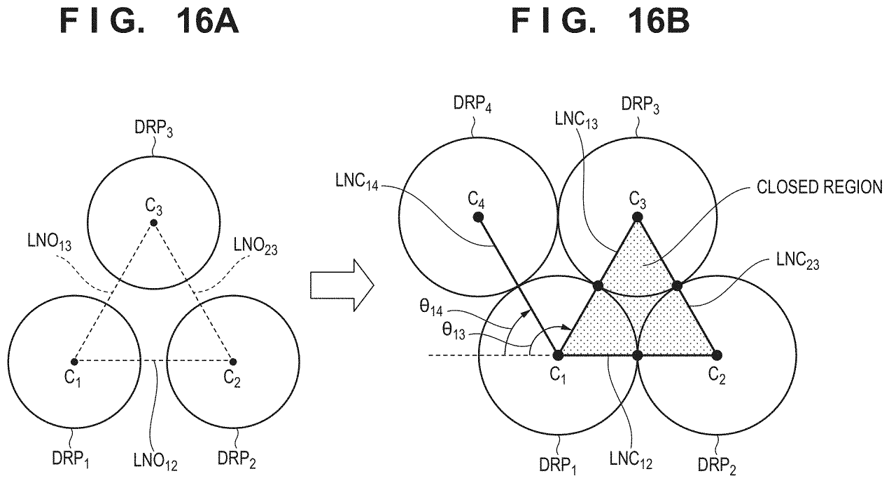

With reference to FIGS. 16A and 16B, the determination as to the presence/absence of the closed region will be more specifically described. FIG. 16A is a view showing the spreading states of the droplet components at a given time, and FIG. 16B is a view showing the spreading states of the droplet components after an elapse of a given time period from the state shown in FIG. 16A. In FIGS. 16A and 16B, a link LN connects the droplet components adjacent to each other generated in step S202.

At the time shown in FIG. 16A, the link connecting a representative point C₁ of a droplet component DRPᵢ and a representative point C₃ of a droplet component DRP₃ is determined to be an open link LNO₁₃. Similarly, the link connecting a representative point C₂ of a droplet component DRP₂ and the representative point C₃ of the droplet component DRP₃ is determined to be an open link LNO₂₃. Similarly, the link connecting the representative point C₁ of the droplet component DRPᵢ and the representative point C₂ of the droplet component DRP₂ is determined to be an open link LNO₁₂. As shown in FIG. 16B, after the elapse of the given time period, these links are determined to be closed links LNC₁₃, link LNC₂₃, and link LNC₁₂ (that is, the droplet component DRP₁, the droplet component DRP₂, and the droplet component DRP₃ merge with each other). As shown in FIG. 16B, if the closed link LNC exists, the presence/absence of a closed region is determined.

Next, a method of determining the presence/absence of a closed region will be described. First, based on the determination as to opening/closing of the link, among the links each having transitioned from the open link to the closed link, the closed link in a region of interest is selected as the starting point. Then, at the closed link serving as the starting point, it is determined whether the adjacent link is the closed link. If the adjacent link is the closed link, this adjacent closed link is selected as the starting point. Then, using the adjacent closed link as the starting point, it is determined whether its adjacent link is the closed link. By repeating such a process, if a closed figure is formed by the links selected as the closed links, it is determined that a closed region exists. Note that if a plurality of adjacent closed links exist upon selecting the adjacent closed link, by continuing to select the adjacent closed link having a largest (or smallest) angle with the closed link serving as the starting point, the closed region can be appropriately extracted.

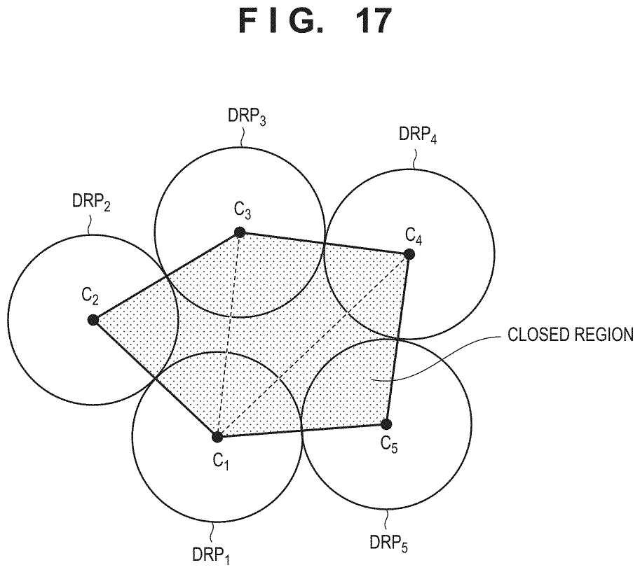

With reference to FIG. 16B, the method of determining the presence/absence of a closed region will be more specifically described. First, the closed link LNC₁₂ newly determined to be the closed link is selected as the link serving as the starting point. Then, by paying attention to one of the nodes (droplet components DRP₁ and DRP₃) forming the closed link LNC₁₂, the closed link is searched for among the adjacent links starting from the node of interest. Here, for the node of the droplet component DRP₁, the closed links LNC₁₄ and LNC₁₃ are candidates. Note that the closed link LNC₁₄ is a closed link corresponding to the link connecting the representative point C₁ of the droplet component DRPᵢ and a representative point C₄ of a droplet component DRP₄. Then, an angle θ₁₄ between the closed link LNC₁₂ and the closed link LNC₁₄ is compared with an angle θ₁₃ between the closed link LNC₁₂ and the closed link LNC₁₃, and the closed link having the larger angle is selected as the closed link serving as the next starting point. Here, the angle θ₁₃ is larger than the angle θ₁₄. Accordingly, the closed link LNC₁₃ is selected as the closed link serving as the next starting point. By repeating the process as described above, when the adjacent closed link is selected using the closed link LNC₂₃ as the starting point, the link LNC₁₂ already selected is selected again. Thus, it is determined that a closed region is formed. FIG. 17 shows a closed region formed by five droplet components DRP₁, DRP₂, DRP₃, DRP₄, and DRP₅. Also in FIG. 17, as in FIG. 16, by repeating the selection of the adjacent closed link, it is possible to determine the presence/absence of a closed region formed by a larger number of droplet components.

In step S207, mering information is calculated using the determination result as to opening/closing of the link LN and the determination result as to the presence/absence of a closed region. The merging information means an evaluation value for evaluating the relationship regarding the degree of merging with adjacent droplets. In this embodiment, the amount of a bubble included in the closed region formed by a plurality of closed links adjacent to each other is used as the merging information.

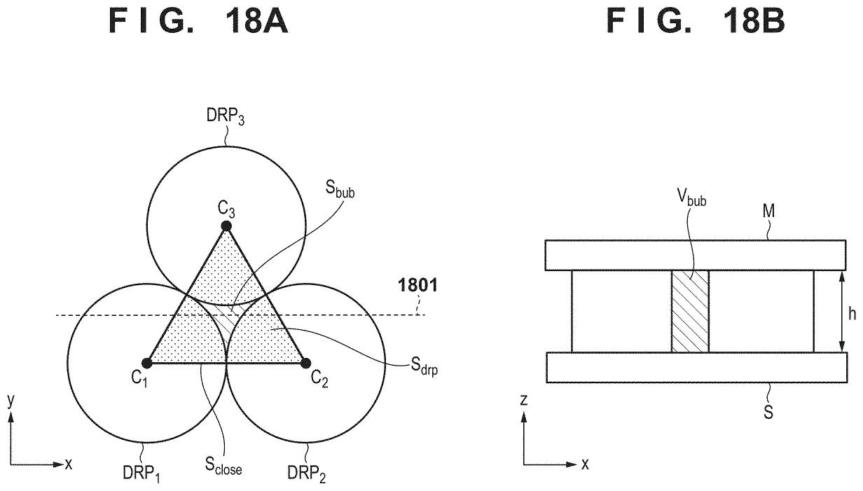

FIGS. 18A and 18B are views for describing a method of calculating the amount of a bubble included in the closed region. In this embodiment, as the merging information, an amount V_{bub} of the bubble included in the closed region formed by the droplet components DRP₁, DRP₂, and DRP₃ is calculated. FIG. 18A shows the state of a substrate S when viewed from above, and FIG. 18B shows a state of the substrate S when viewed from the side along a line 1801 shown in FIG. 18A.

First, as shown in FIG. 18A, a bubble area S_{bub} of the bubble when viewed from the above is calculated. As expressed by equation (3), the bubble area S_{bub} is obtained as the difference between a closed region area S_{close} bordered by the links forming the closed region and an area S_{drp} of the droplet components DRP₁, DRP₂, and DRP₃ included in the closed region:

S_{bub}=S_{close}−S_{drp} (3)

Referring to FIG. 18B, the amount V_{bub} of the bubble is the amount of the bubble sandwiched between the mold M and the substrate S, and obtained by following equation (4). Here, h is the distance (height) between the mold M and the substrate S.

V_{bub}=S_{bub}×h (4)

Note that in equation (4), the volume of the bubble is calculated as the amount of the bubble included in the closed region, but the present invention is not limited to this. For example, as the amount of the bubble included in the closed region, the number n_{bub} of molecules of a gas contained in the bubble may be calculated as expressed by following equation (5). Here, R is a gas constant, and T is the temperature.

$${n}_{b u b} = \frac{{P}_{p u b} {V}_{b u b}}{R T} \qquad ( 5 )$$

In this manner, the number of molecules of a gas contained in the bubble is obtained as the amount proportional to the product of the pressure of the gas in the bubble and the volume of the bubble. Note that the pressure of the gas can be calculated as, for example, a force received by the bubble when pressed by the mold M.

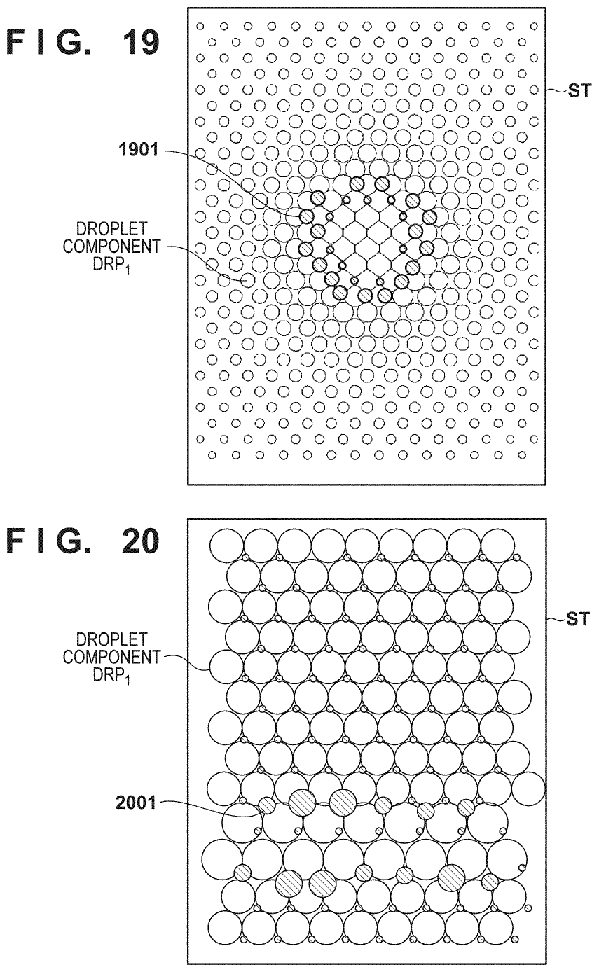

The merging information obtained as described above is displayed in step S210 on a display 30 together with information indicating the state (spreading state) of the droplet of the curable composition IM corresponding to the merging information. FIG. 19 is a view showing an example of an image including the merging information displayed on the display 30 in step S210. In FIG. 19, as the merging information, the amount of the bubble calculated by equation (4) or (5) is displayed with respect to the distribution of droplet components DRPᵢ arranged in a shot region ST of the substrate S. More specifically, the amount of the bubble is displayed by the bubble chart display, in which the size of a circle 1901 is changed in accordance with the amount (size) of the bubble. For example, as shown in FIG. 20, the droplet components DRPᵢ are displayed, and the size of a circle 2001 indicating the amount of the bubble included in the closed region is changed in accordance with the amount of the bubble. With this, it is possible to visually grasp the amount of the bubble (the distribution state thereof) included in the closed region.

In this embodiment, a case has been described in which the size of the circle representing the bubble is changed in accordance with the amount (size) of the bubble, but the present invention is not limited to this. For example, in accordance with the magnitude of the amount of the bubble, the hue in the closed region corresponding to the amount of the bubble may be changed.

In step S208, based on the merging information calculated in step S207 and the time-sequential change thereof, the presence/absence of an abnormality in the behavior of the curable composition IM at the corresponding time is determined (that is, an abnormality in the behavior of the curable composition IM is detected).

An example of a method of detecting an abnormality in the behavior of the curable composition IM will be described below. In this embodiment, the presence/absence of an abnormality is determined (an abnormality is detected) by following the procedure including (1) and (2) below.

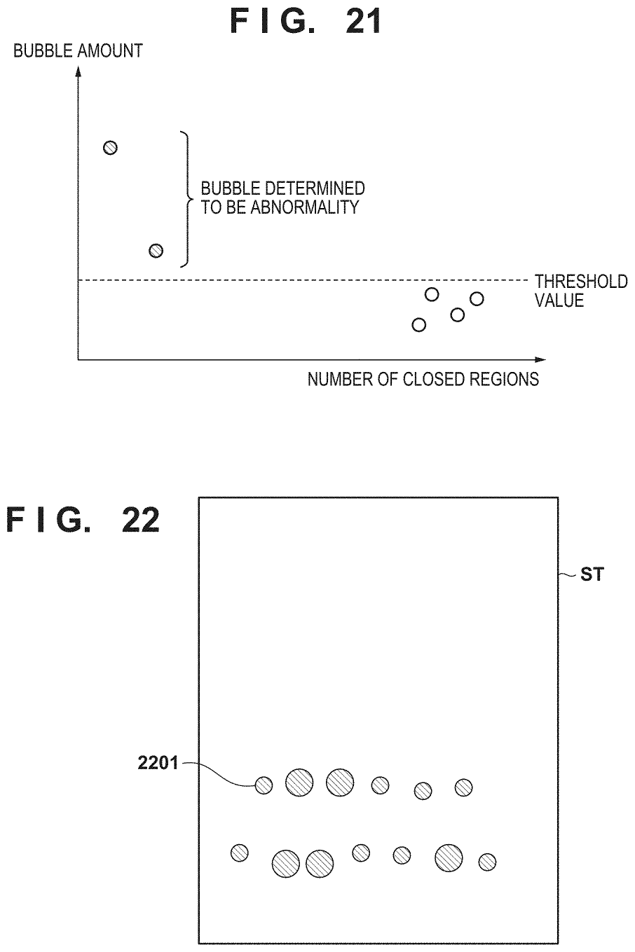

(1) As shown in FIG. 21, a graph regarding the amount of the bubble included in the closed region is generated. In FIG. 21, the ordinate represents the amount of the bubble included in the closed region, and the abscissa represents the number of closed regions each including the bubble.

(2) In the graph shown in FIG. 21, a threshold value for the amount of the bubble is set, and the bubble whose amount is larger than the threshold value is determined to be abnormal. Then, the droplet forming the closed region including the abnormal bubble is determined to be abnormal. Note that the threshold value is set in accordance with the filling time of filling the mold M with the curable composition IM. For example, if the filling time is long, the amount of the bubble absorbed during the filling period increases. Thus, a large threshold value is set. On the other hand, if the filling time is short, the amount of bubble absorbed during the filling period decreases. Thus, a small threshold value is set.

The amount of the bubble determined to be abnormal as described above is displayed in step S210 on the display 30 as the abnormality information indicating the presence/absence of the abnormality in the behavior of the curable composition IM. FIG. 22 is a view showing an example of an image including the abnormality information displayed on the display 30 in step S210. In FIG. 22, only the bubbles determined to be abnormal are displayed as circles whose sizes are changed in accordance with the amount of the bubble. With this, only the bubble determined to be abnormal can be visually checked, so that the portion of each droplet component DRPᵢ where the abnormality has occurred can be readily grasped. Note that in this embodiment, only the bubble determined to be abnormal is displayed, but the information indicating the states (spreading states) of the droplets of the curable composition IM may be displayed together. With this, the portion (droplet) where the abnormality has occurred can be visually grasped. Further, the bubble determined to be abnormal may be blinked to discriminate it from other bubbles.

The calculation step including steps S203, S204, S205, S206, S207, and S208 is executed for a plurality of preset times. For example, the plurality of times are arbitrarily set within a period from a time when the mold M starts to lower from the initial position until a time when the mold M contacts a plurality of droplets, the plurality of droplets are crushed to spread, and merge with each other to finally form one film, and the curable composition should be cured. The plurality of times are typically set at a predetermined time interval.

In step S209, it is determined whether the time in calculation has reached the end time. As described above, if the time in calculation has not reached the end time, the time advances to the next time, and the process shifts to step S203; otherwise, the process shifts to step S210. In an example, in step S209, the current time is advanced by a designated time step, thereby setting a new time. Then, if the new time has reached the end time, the process shifts to step S210.

As has been described above, in step S210, at least one of the image shown in FIG. 19, the image shown in FIG. 20, and the image shown in FIG. 22 is displayed on the display 30. In step S210, for example, in accordance with a user request, the image shown in FIG. 19, the image shown in FIG. 20, and the image shown in FIG. 22 may be switched and displayed, or some or all of the image shown in FIG. 19, the image shown in FIG. 20, and the image shown in FIG. 22 may be displayed.

According to this embodiment, it becomes possible to determine the presence/absence of an abnormality in the behavior of each of the plurality of droplets of the curable composition IM arranged on the substrate S, particularly, in spreading of the droplet, and visually recognize it. Therefore, it is possible to provide a technique advantageous in detecting the abnormality in the behavior of the curable composition IM in the process of forming a film of the curable composition IM in a film forming apparatus IMP. Further, by repeatedly adjusting the arrangement pattern of the droplets of the curable composition IM using the simulation method according to this embodiment and the results obtained thereby, it becomes possible to readily set a condition for the process of forming a film of the curable composition IM while reducing abnormalities in the process.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

The film forming apparatus IMP incorporating the simulation apparatus 1 controls, based on prediction of the behavior of the curing composition performed by the simulation apparatus 1, a process of bringing the curable composition arranged on the first member into contact with the second member and forming a film of the curable composition.

An article manufacturing method according to the present invention includes a step of determining, while repeating the simulation method described above, a condition for a process of bringing the curable composition arranged on the first member into contact with the second member and forming a film of the curable composition, and a step of executing the process in accordance with the condition. So far, a mode in which the mold includes a pattern has been described, but the present invention is also applicable to a mode in which a substrate includes a pattern.

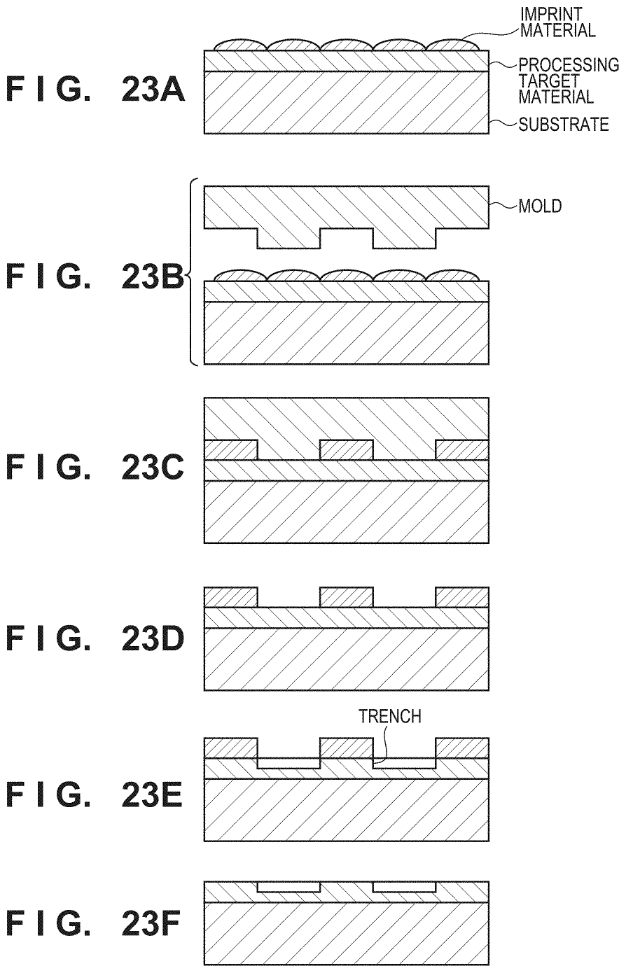

FIG. 23A to FIG. 23F show a more specific example of a method of manufacturing an article. As illustrated in FIG. 23A, the substrate such as a silicon wafer with a processed material such as an insulator formed on the surface is prepared. Next, an imprint material (curable composition) is applied to the surface of the processed material by an inkjet method or the like. A state in which the imprint material is applied as a plurality of droplets onto the substrate is shown here.

As shown in FIG. 23B, a side of the mold for imprint with a projection and groove pattern is formed on and caused to face the imprint material on the substrate. As illustrated in FIG. 23C, the substrate to which the imprint material is applied is brought into contact with the mold, and a pressure is applied. The gap between the mold and the processed material is filled with the imprint material. In this state, when the imprint material is irradiated with light serving as curing energy through the mold, the imprint material is cured.

As shown in FIG. 23D, after the imprint material is cured, the mold is released from the substrate. Thus, the pattern of the cured product of the imprint material is formed on the substrate. In the pattern of the cured product, the groove of the mold corresponds to the projection of the cured product, and the projection of the mold corresponds to the groove of the cured product. That is, the projection and groove pattern of the mold is transferred to the imprint material.

As shown in FIG. 23E, when etching is performed using the pattern of the cured product as an etching resistant mask, a portion of the surface of the processed material where the cured product does not exist or remains thin is removed to form a groove. As shown in FIG. 23F, when the pattern of the cured product is removed, an article with the grooves formed in the surface of the processed material can be obtained. The pattern of the cured material is removed here, but, for example, the pattern may be used as a film for insulation between layers included in a semiconductor element or the like without being removed after processing, in other words as a constituent member of the article.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent application No. 2020-128506 filed on Jul. 29, 2020, which is hereby incorporated by reference herein in its entirety.

What is claimed is:

1. A simulation method of predicting a behavior of a curable composition in a process of bringing a plurality of droplets of the curable composition arranged on a first member into contact with a second member and forming a film of the curable composition in a space between the first member and the second member, the method comprising:
for each of the plurality of droplets of the curable composition, obtaining, based on whether the droplet merges with an adjacent droplet, an evaluation value for evaluating a relationship regarding a degree of merging with the adjacent droplet, and
displaying, together with information indicating a state of the droplet corresponding to the evaluation value, the evaluation value obtained in the obtaining.

2. The method according to claim 1, wherein
in the obtaining, for each of the plurality of droplets of the curable composition, a ratio of a part contacting a contour of the adjacent droplet to a whole circumference of a contour of the droplet is obtained as the evaluation value.

3. The method according to claim 1, further comprising
determining, for each link generated by setting a node at each of the plurality of droplets of the curable composition and connecting the nodes, the link to be a closed link if the droplets forming the link merge with each other,
wherein in the obtaining, for each of the plurality of droplets of the curable composition, a ratio of the closed links to the links of the droplets is obtained as the evaluation value.

4. The method according to claim 3, wherein
in the displaying, the ratio obtained in the obtaining is displayed in color.

5. The method according to claim 1, further comprising
determining, for each link generated by setting a node at each of the plurality of droplets of the curable composition and connecting the nodes, the link to be a closed link if the droplets forming the link merge with each other,
wherein, in the obtaining, an amount of a bubble included in a closed region formed by a plurality of the closed links adjacent to each other is obtained as the evaluation value.

6. The method according to claim 5, wherein
in the displaying, the amount of the bubble obtained in the obtaining is displayed by a size of a circle.

7. The method according to claim 1, further comprising
determining presence/absence of an abnormality in the behavior of the curable composition in the process based on the evaluation value obtained in the obtaining.

8. The method according to claim 7, further comprising
displaying, together with information indicating states of the plurality of droplets of the curable composition, information indicating the presence/absence of the abnormality in the behavior of the curable composition in the process determined in the determining.

9. The method according to claim 8, wherein
in the determining, if it is determined that an abnormality exists in the behavior of the curable composition in the process, the droplet where the abnormality has occurred is specified from the plurality of droplets of the curable composition.

10. The method according to claim 9, further comprising
displaying the droplet, where the abnormality has occurred, specified in the determining so as to be distinguishable from a droplet where no abnormality has occurred.

11. The method according to claim 10, wherein
in the distinguishably displaying the droplet, the droplet, where the abnormality has occurred, specified in the determining and the droplet where no abnormality has occurred are displayed in colors different from each other.

12. The method according to claim 10, wherein
in the distinguishably displaying the droplet, the droplet, where the abnormality has occurred, specified in the determining is blinked.

13. A simulation apparatus that predicts a behavior of a curable composition in a process of bringing a plurality of droplets of the curable composition arranged on a first member into contact with a second member and forming a film of the curable composition in a space between the first member and the second member, wherein,
for each of the plurality of droplets of the curable composition, based on whether the droplet merges with an adjacent droplet, an evaluation value for evaluating a relationship regarding a degree of merging with the adjacent droplet is obtained, and
the evaluation value is displayed together with information indicating a state of the droplet corresponding to the evaluation value.

14. A film forming apparatus incorporating a simulation apparatus defined in claim 13, wherein
a process of bringing a plurality of droplets of the curable composition arranged on a first member into contact with a second member and forming a film of the curable composition in a space between the first member and the second member is controlled based on prediction of a behavior of the curable composition performed by the simulation apparatus.

15. An article manufacturing method comprising;
determining, while repeating a simulation method defined in claim 1, a condition for a process of bringing a plurality of droplets of a curable composition arranged on a first member into contact with a second member and forming a film of the curable composition in a space between the first member and the second member, and
executing the process in accordance with the condition.

16. A non-transitory storage medium storing a program for causing a computer to execute a simulation method defined in claim 1.
